(19) United States
(12) Patent Application Publication
(10) Pub. No.: US 2012/0288077 A1
(43) Pub. Date: Nov. 15, 2012

(54) METHOD AND SYSTEM FOR BILLING TELEPHONE CALLS

(75) Inventors: William L. Perna, Las Vegas, NV (US); Vicki Crowder, Las Vegas, NV (US)

(73) Assignee: CUSTOM TELECONNECT, INC., Las Vegas, NV (US)

(21) Appl. No.: 13/470,145

(22) Filed: May 11, 2012

Related U.S. Application Data
(60) Provisional application No. 61/485,295, filed on May 12, 2011.

(51) Int. Cl. H04M 15/00

(52) U.S. Cl. 379/114.21

(57) ABSTRACT

Various implementations described herein include method and system establishing and billing a voice communication between a calling party and a called party. The method and system described herein enable placing collect calls and third party calls to the called party by billing a credit or debit card associated with the called party or by billing the called party through their mobile or wireless provider.

### CROSS-REFERENCE TO RELATED APPLICATIONS

This application claims the benefit under 35 U.S.C. §119(e) of U.S. Provisional Application No. 61/485,295, filed on May 12, 2011, and titled “METHOD AND SYSTEM FOR BILLING TELEPHONE CALLS.” The prior application is hereby incorporated by reference herein in its entirety.

### BACKGROUND

1. Field of the Invention

This application relates to the field of voice communication networks. Various implementations disclosed in this application disclose systems and methods for billing telephone calls e.g. collect and third party calls.

2. Description of the Related Art

Telecommunication providers may not have the ability to bill collect calls and other third party calls to certain destination numbers e.g. destination numbers that are serviced by wireless/mobile carrier or destination numbers serviced by competitive local exchange carriers (CLECs) that do not have a billing agreement with Local Exchange Carrier (LEC). Systems and methods described herein can be used to complete and bill collect calls and third party calls to destination numbers that cannot be billed for collect or third party calls.

### SUMMARY

The systems, methods and devices of the disclosure each have several innovative aspects, no single one of which is solely responsible for the desirable attributes disclosed herein.

Some innovative aspects of the subject matter described in this disclosure can be implemented in a system configured to process and bill voice communication calls. The system can include a processor that is configured to place calls from a calling party to a called party. The processor can be further configured to receive information associated with an identity of the calling party; receive a destination number associated with the called party; place a call to the destination number; prompt the called party to accept the call by paying for the call or deny the call; process payment for the call; and complete the call by establishing a voice connection between the called party and the calling party.

Various implementations of the system can include a database, an interactive voice recorder and other networking/telecommunication equipment (such as switches, routers, computing platforms, etc.) in electrical communication with the processor. In various implementations of the system, the processor may be configured to place calls to un-billable destination numbers, such as, for example, telephone numbers serviced by mobile/wireless carriers, VoIP service providers, cable providers, etc.

Another innovative aspect of the subject matter can be implemented in a method of establishing voice communication between a calling party at a source location and a called party at a destination location. The method includes receiving information associated with an identity of the calling party; receiving a destination number associated with the called party; placing a call to the called party at the destination number; prompting the called party to accept the call by paying for the call or deny the call; processing payment for the call; and establishing a voice connection between the called party and the calling party. The method can be implemented by a processor that is configured to execute a set of instructions.

Various implementations of the method can include processing payment for the call by prompting the called party to enter information regarding a credit or a debit card associated with the called party; validating the credit or debit card information; and placing a hold on the credit card or the debit card for a certain amount of money. In various implementations, prompting the called party can be accomplished by an interactive voice recorder in communication with the processor that is used to implement the method.

Various implementations of the method can include generating a call detail record after the call is terminated; processing the call detail record to obtain the amount of time for the call; calculating an amount of money to be billed for the call based on the amount of time for the call; billing the credit or debit card the amount of money to be billed; and removing the hold on the credit or debit card. Various implementations of the method can further include billing the called party through the wireless or mobile service provider; and transmitting a text message including a receipt for the amount billed. In some implementations, the text message can also include an inspirational quote of the day. In various implementations, the text message can be transmitted using SMS platform.

Details of various implementations of the subject matter described in this specification are set forth in the accompanying drawings and the description below. Other features, aspects, and advantages will become apparent from the description, the drawings, and the claims.

### BRIEF DESCRIPTION OF THE DRAWINGS

FIGS. 1A and 1B are flow charts illustrating different methods of processing collect or a third party call from a source location to a destination number.

FIG. 2 illustrates an implementation of a voice communication network that can establish voice connection between a calling party and a called party after charging a credit or debit card associated with the called party.

FIG. 3 and FIG. 3A are flow charts illustrating an implementation of a method for billing a collect or a third party call from a calling party to a called party wherein a credit/debit card associated with the called party is billed.

FIG. 4 illustrates an implementation of a voice communication network that can establish voice connection between a calling party and a called party after billing the called party through their communication service provider.

FIG. 5 and FIG. 5A are flow charts illustrating an implementation of a method for billing a collect or a third party call from a calling party to a called party wherein the called party is billed through their communication service provider.

Like reference numbers and designations in the various drawings indicate like elements. Note that the relative dimensions of the figures may not be drawn to scale.

### DETAILED DESCRIPTION

The following detailed description is directed to certain specific implementations of the invention. However the invention can be embodied in multiple ways. As will be apparent from the following description even though the invention is described in reference to methods and systems for completing collect calls and third party calls between a calling party and a called party, the implementations described herein can be advantageous in establishing and billing other types of audio and video communications.

Various implementations described herein provide systems and methods for billing collect calls/third party calls to destination numbers that cannot be billed for such calls, e.g. destination numbers serviced by mobile/wireless carriers, destination numbers serviced by voice-over-IP (VOIP) providers, destination numbers serviced by competitive local exchange carriers (CLECs) that do not have a billing agreement with Local Exchange Carrier (LEC), etc. The systems and methods disclosed in this application are directed towards computing platforms including a collection of hardware components and software applications that can process and bill collect calls/third party calls to wireless, VOIP, satellite or other voice communication systems. The systems and methods disclosed herein can provide other functionalities such as verify the phone numbers associated with source and destination locations, verify the identity and/or billing information of users at source and destination locations, store or record part of or the entire conversation, condition the voice signals to provide desired voice quality, assist in routing the voice signals from the source to the destination, generate invoices, etc. The systems and methods disclosed herein can be deployed at call processing centers that perform some or all of the above discussed functions. The systems and methods disclosed herein can be integrated with existing network architectures and equipments at the call processing centers or include proprietary hardware components and/or software frameworks.

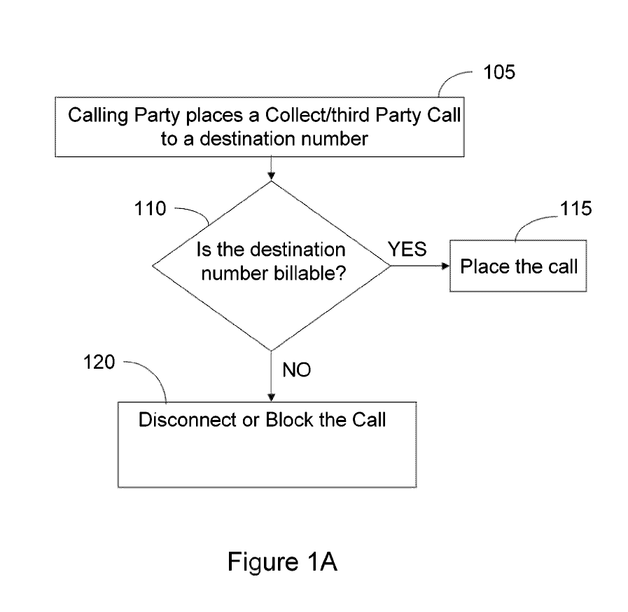

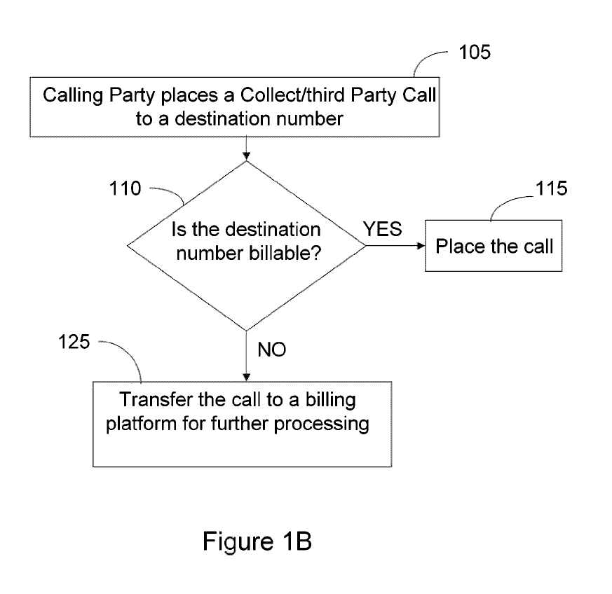

FIGS. 1A and 1B are flow charts illustrating different methods of processing collect or a third party call from a source location to a destination number. As illustrated in block 105 of FIG. 1A, when an individual or a calling party places a collect/third party call from a source location to a called party at a destination location, the telephone number of the called party at the destination location is looked up by the service provider (e.g. the internet, cable, wireless or telephone company) providing service at the source location through the Line Information Database (LIDB), which includes information (e.g. caller ID records) of the numbers that are serviced by traditional telephone companies. In various implementations, the phone switches (e.g. Class 5 switches) at the call processing center that receive the telephone number at the destination from the source location can use SS7 signaling protocol to access the LIDB and verify the destination number. The LIDB can include the Operation Company Number (OCN), which refers to the identity of the provider that provides service to the destination number. Once the OCN is established it is then determined whether the destination number is billable or not, as illustrated in block 110. If the destination number is determined as being billable, the collect/third party call is placed and voice connection between the calling party and a called party at the destination number is established. However, if it is determined that the destination number is un-billable, then the call is traditionally disconnected or blocked as illustrated in block 120. In various implementations, the individual or the calling party at the source location can be informed that the call as dialed cannot be completed and may be asked to provide a different destination number.

The systems and methods described herein advantageously allow the call from the source location to be transferred to a proprietary billing platform for further processing as illustrated in block 125 of FIG. 1B if the processing centers are unable to verify the destination number or make the determination that the destination number is un-billable. The proprietary billing platform may be owned and operated by a third party service provider different from the providers servicing the source and destination locations. In various implementations, the proprietary billing platform can be integrated with the network equipments at the processing center that receives the call from the source location. In some implementations, the call may be transferred to a different processing center that is equipped with the proprietary billing platform. In various implementations, the proprietary billing platform can be completely automated such that the individual or the calling party at the source location does not require assistance from a live operator. In some implementations, the proprietary billing platform can be partially automated such that the individual or the calling party at the source location is assisted by a live operator. The proprietary billing platform can advantageously allow billing and completion of collect/third party calls, that would otherwise by blocked, dropped or disconnected. Accordingly, the proprietary billing platform can provide a service that is currently not being provided by traditional telephone service provides. In various implementations, charging/invoicing of the collect/third party calls can be performed before voice communication between the calling party and the called party is established. Charging for the collect/third party calls prior to the establishment of voice connection between the calling party and the called party can be advantageous in streamlining the billing process and/or reducing billing overheads. For example, charging/invoicing the called party prior to completing the call can reduce the costs associated with collecting charges after the collect/third party call has been completed. In various implementations, the called party may receive a text message including a receipt for the charges associated with receiving the collect/third party call after the call is completed.

The proprietary billing platform described herein allow a calling party or an individual to place a collect/third party call from an originating number to a called party or a person receiving the call at a destination location wherein either (i) a credit/debit card associated with the called party is charged for the collect/third party call prior to completing the call or (ii) called party is billed for the collect/third party call through the service provider (e.g. mobile/wireless provider) associated with the telephone number at the destination location. In various implementations, described herein the called party or the person receiving the call may receive a receipt on their phone for the collect/third party call via a text messaging platform (e.g. SMS). In some implementations, the called party or the person receiving the call may also receive an inspirational quote of the day on their phone along with the invoice. In some implementations, the called party may receive a receipt for the collect/third party call by way of an email or mail. In some implementations, the charges incurred by the called party for the collect/third party call may appear in a monthly invoice generated by the service provider servicing the destination location. The systems and methods described herein can be useful for placing collect calls to traditionally un-billable telephone numbers (e.g. telephone numbers associated with wireless or VoIP service providers) from source locations such as prisons, hospitals, airports, police stations, pay phones, locations outside the country, etc. Various implementations of proprietary billing platforms are further described below.

### Automated Bank Card Collect Billing Platform

The Automated Bank Card Collect (ABC) billing platform is developed to process and bill collect and third party calls to traditionally un-billable telephone numbers (e.g. telephone numbers associated with wireless or VoIP service providers). As discussed above, the un-billable telephone numbers can be services by carriers that belong to the following segments: Competitive Local Exchange Carriers, Wireless Carriers and Voice over Internet Providers (VoIP), etc.

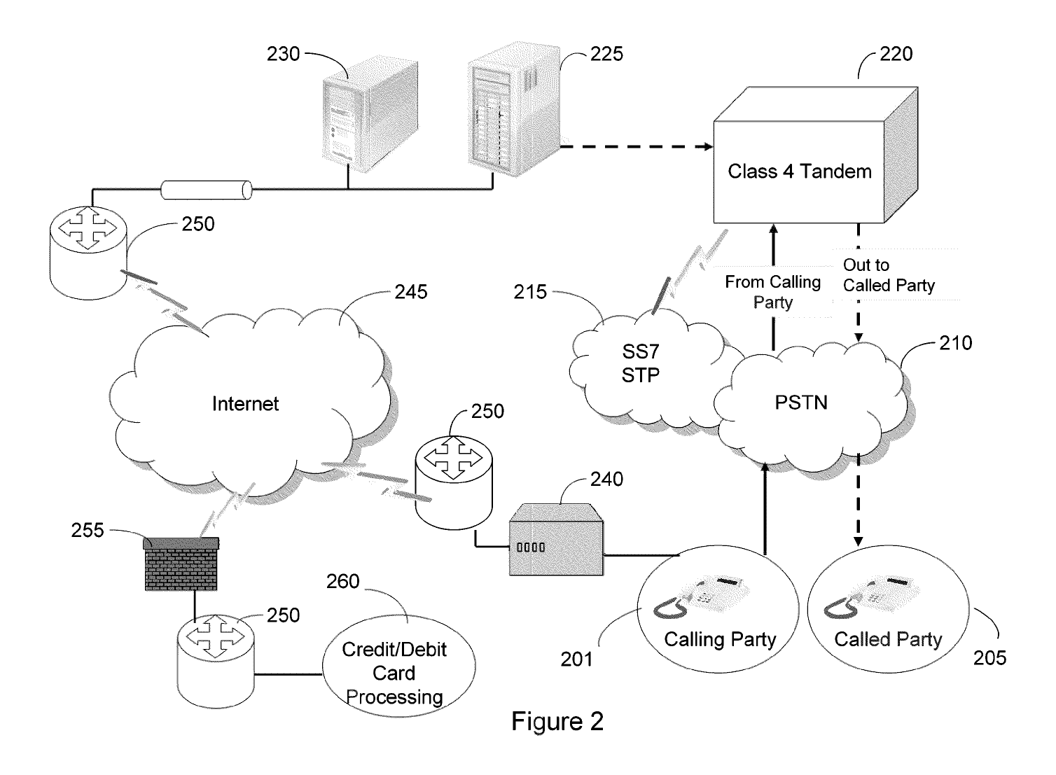

FIG. 2 illustrates an implementation of a voice communication network including the ABC billing platform. In various implementations, the ABC billing platform can include a processor, a Class 4 Tandem Switch 220, an interactive voice response (IVR) system 225, a database 230, cross connects or switches 250, and a voice over IP gateway (VoIP) interface 240. In various implementations, the ABC billing platform may be secured behind a firewall 255. In various implementations, the ABC billing platform may be in communication with a credit card or a debit card processing center 260 that can validate/verify/process credit and debit card transactions. In various implementations, the communication link between ABC billing platform and the credit card or a debit card processing center 260 can be established through a secure channel over the Internet 245. In various implementations, calls from the calling party may be routed to the destination or the billing platform via the VoIP gateway interface 240. In some implementations, the ABC platform may be implemented on a system that includes a server based micro processor design. The ABC billing platform can include software applications that are developed using an operating systems e.g. Linux operating system, UNIX operating system, etc. Call flows recording and the integrated voice response features may be created or developed using a programming language e.g. Python. Telephony processing may be accomplished through utilization of software e.g. Asterisk® while Voice over Internet protocol (VoIP) may be used to ingress and egress the billing platform. Database storage and retrieval may be handled utilizing a database management system e.g. MySQL. The ABC billing platform may be integrated with existing legacy time domain multiplexing (TDM) based operator service platforms.

The processor of the ABC billing platform can be configured to place calls from a calling party to a called party. In various implementations, the processor can be configured to receive information associated with the identity of the calling party and receive a destination number associated with the called party. The processor may be configured to place a call to the destination number. The processor may be configured to prompt the called party through the IVR 225 to accept the call by paying for the call or deny the call. The processor may be configured to process payment information for the call once the called party has accepted the call. The processor may be configured to complete the call by establishing a voice connection between the called party and the calling party. These and other functions that can be performed by the processor included in the ABC billing platform is described in detail below.

When an individual/calling party originates a collect/third Party call through a standard operator service platform from a source location 201 to another individual/called party at a destination location 205 they may enter the destination number in a 0+ dialing sequence (0+NPA-NXX-XXXX). The destination number can be the number associated with a telephone, a mobile/wireless device or a VoIP device at the destination location 205. In a 0− dial in sequence, when prompted the calling part may enter the destination number (NPA-NXX-XXXX). As discussed above, the called number may be looked up by the provider through the LIDB which includes the information of telephone numbers serviced by traditional phone companies. The LIDB contains the Operation Company Number (OCN), which is the identity of the provider that provides service to the telephone at the destination location. Once the OCN is established it is then determined whether the destination number is billable or not. If the number is billable the call is processed by existing processing methods. However, if the number is determined to be not billable, the call may be forwarded to the ABC billing platform.

The ABC billing platform includes a proprietary process that is implemented by a processor in electrical communication with several other networking/telecommunication devices. Instead of blocking collect/party calls to un-billable destination numbers, the call maybe extended out to the ABC billing platform. As described above, this process can advantageously allow calls to be placed to un-billable destination numbers and provide a level of service that is not currently being provided. The ABC billing platform can process and complete collect/third party calls from the source location 201 to traditionally un-billable telephone numbers at the destination location 205 by securing billing from the called party with either a credit or a debit card. In various implementations, the ABC billing platform may be an automated process that does not involve live operator intervention. Various implementations of the ABC billing platform can include a unique application which relies on the “Called Party” to accept charges with a credit card or debit card. In contrast, in all previous calling scenarios credit card calling was initiated by the “Calling Party” that placed a call utilizing a credit card to secure billing.

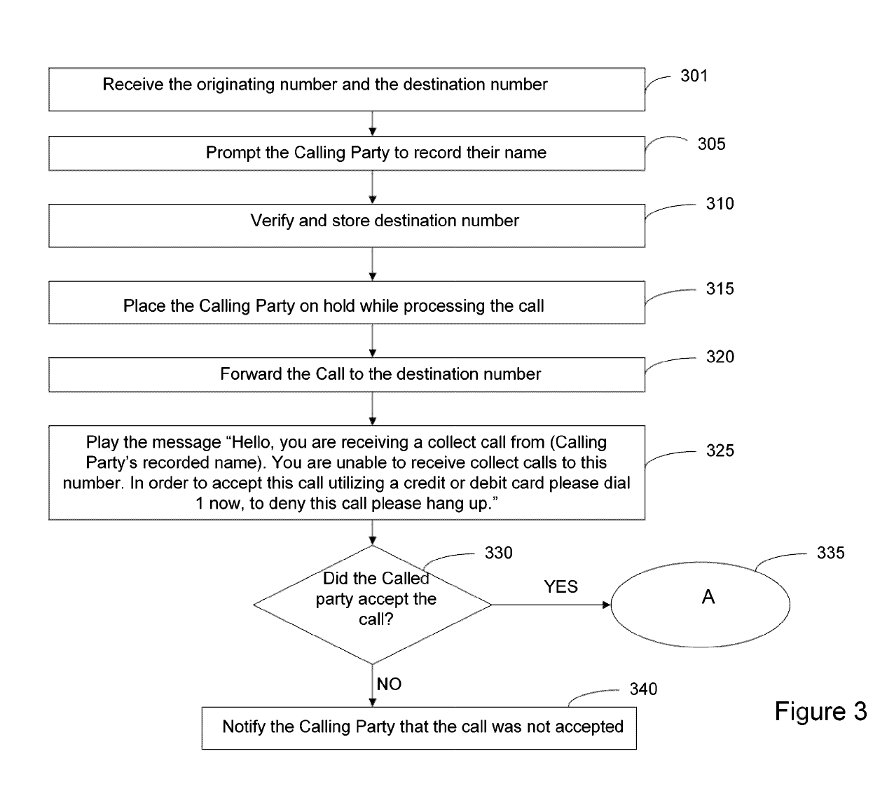

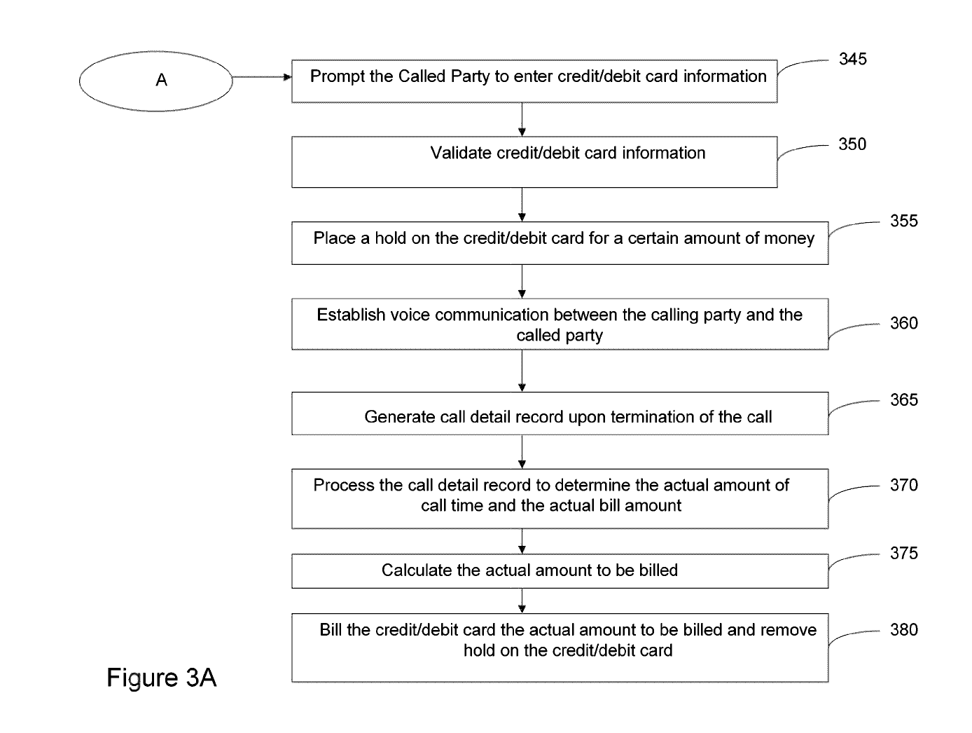

FIGS. 3 and 3A are flow charts illustrating an implementation of a method for billing a collect/third party call using the ABC billing platform. Once the operator service platform identifies the called number as being un-billable, for example by determining that the OCN is a carrier with no billing agreement, the call is sent to the ABC platform for processing. The destination number is sent along with the originating number in a feature group D calling (FG-D) format to the ABC billing platform as shown in block 301. The calling party is prompted or asked to “Record his or her name at the tone” as shown in block 305. The destination number is verified/checked and optionally stored in a database (e.g. database 230) as shown in block 310. In various implementations, the database 230 can include calling velocity tables that can store the destination number. Upon verification of the destination number, the call is processed and ultimately forwarded (e.g. through the class 4 tandem 220) to the destination number as shown in block 320. The calling party is placed on hold as shown in block 315 while the call is being processed. In some implementations, the calling party may hear music while the call is being processed.

During processing of the call, the called party receives a call from the ABC billing platform and hears a prompt that states, “You are receiving a collect call from (Calling Party's recorded name), you are unable to receive collect calls to this number. In order to accept this call utilizing a credit or debit card please dial 1 now, to deny this call please hang up” as shown in block 325. If the called party denies the call, the calling party is notified that the call was rejected as shown in block 340 and the calling party may be disconnected or the calling party may be asked to enter a different number.

If the called party accepts the call (e.g. by depressing 1 on the keypad) then the methods performs the set of operations shown in FIG. 3A. In various implementations, the calling party maybe advised that the called party has accepted the call and to wait on the line while billing information is secured. The flow chart illustrated in FIG. 3A is directed towards securing billing information from the called party prior to establishing voice connection between the calling party and the called party. In various implementations to secure billing information, the called party maybe prompted to enter a credit/debit card number and security information as shown in block 345. The credit/debit card number and security information maybe validated as shown in block 350 by contacting the credit/debit card processing center 260 through a secure connection e.g. the firewall 255. A hold maybe placed on the credit/debit card for a monetary amount equal to the standard rates applicable for the type of the call and the state in which the call was placed through a secure transaction as shown in block 355.

Subsequent to obtaining billing information voice communication between the calling party and the called party is established as shown in block 360 and the calling party and the called party are placed in voice conference. In some implementations, the calling party may hear a recording “you can go ahead with your call,” before the parties are placed in conference. In various implementations, once the call is terminated after the conference, a call detail record (CDR) maybe generated by the ABC billing platform as shown in block 365. The CDR can be processed to reflect the actual call time and the actual amount to be billed is calculated as shown in block 370. The CDR maybe rated and then transmitted electronically to the credit card processor. The hold on the card is removed and the actual amount is billed to the called parties account as shown in block 380.

### CTI Text Billing Platform

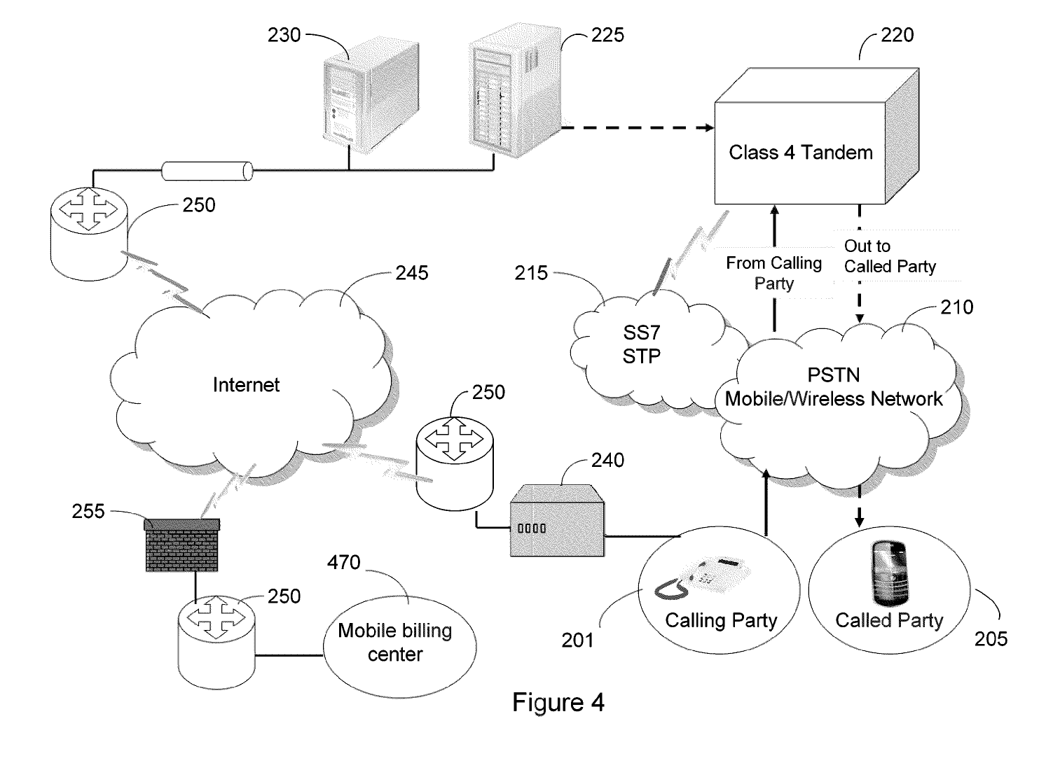

The CTI text billing platform is developed to process and bill collect calls to wireless, Mobile service providers. FIG. 4 illustrates an implementation of a voice communication network including the CTI text billing platform. In various implementations, the systems, software and devices included in the voice communication network including the CTI text billing platform maybe similar to the systems, software and devices described above with reference to FIG. 3. In the network illustrated in FIG. 4, the CTI text billing platform may communicate with a mobile billing center 470 that is associated with the mobile service provider associated with the device at the destination location 205.

When the destination number associated with a mobile device at the destination location 205 to which a calling party places a collect/third Party call is determined to be not billable the call may be forwarded to the CTI text billing platform for further processing.

CTI text billing platform includes a proprietary process that is implemented by a processor in electrical communication with various networking/telecommunication devices. Instead of blocking or dropping collect/third party calls to un-billable mobile/wireless destination numbers, the call maybe extended out to the CTI text billing platform for further processing. This process can advantageously allow calls to be placed to un-billable destination numbers. The CTI text billing platform can place calls out to the destination number by billing the wireless/mobile service provider associated with the mobile/wireless device at the destination location 205. In various implementations, the CTI text billing platform may be an automated process that does not involve live operator intervention. CTI text billing is a unique application which relies on the “Called Party” accepting charges through their mobile provider via Premium Mobile Text Billing. The CTI text billing platform can gain access to the billing centers of majority of mobile/wireless service providers in the country by a unique short code billing process. In various implementations, the billing service can be provided by the CTI text billing platform via Premium Mobile SMS (Short Message Service).

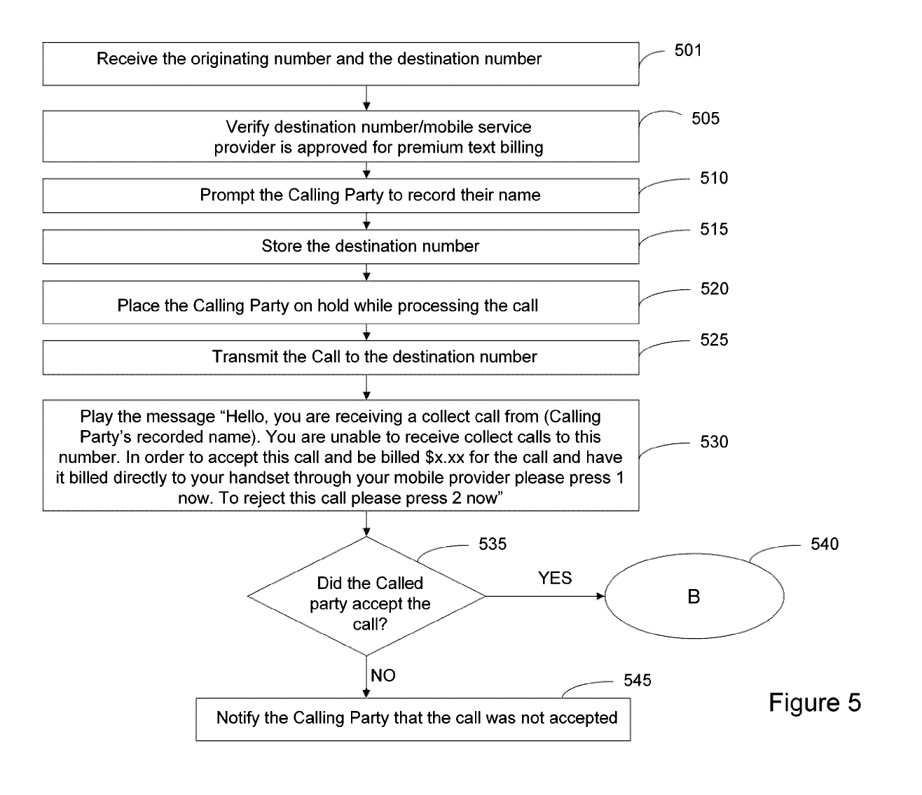

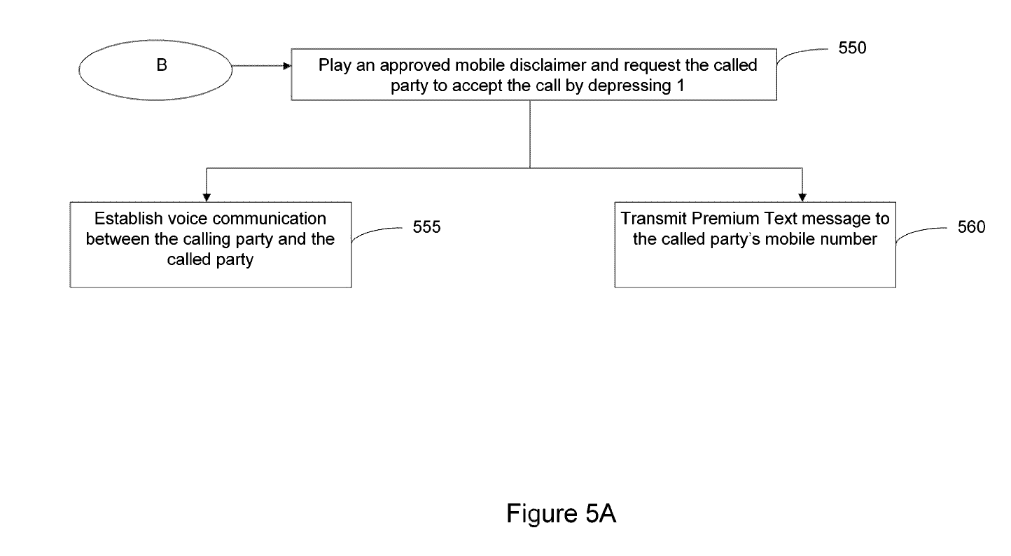

FIGS. 5 and 5A are flow charts illustrating an implementation of a method for billing a collect/third party call using the CTI text billing platform. Once the operator service platform at the processing center that receives the call from the calling party identifies the destination number as being an un-billable mobile/wireless number, for example by determining that the OCN is a carrier with no billing agreement, the call is sent to the CTI text billing platform for further processing. The destination number is sent along with the originating number in a feature group D calling (FG-D) format to the CTI text billing platform as shown in block 501. In various implementations, the destination number maybe checked though a SMS aggregator to verify the Operator ID and/or that the mobile service provider associated with the device at the destination location 205 is approved for premium text billing as shown in block 505. Once it is verified that the mobile service provider is approved for premium text billing the calling party is asked to “Record his or her name at the tone” as shown in block 510. In various implementations, the destination number maybe checked and stored in a database (e.g. database 230) as shown in block 515. In various implementations, the database 230 can include calling velocity tables that can store the destination number. Upon verification the call is processed and forwarded (e.g. through the class 4 tandem 220) to the mobile device at the destination location as shown in block 525. The calling party is placed on hold as shown in block 520 while the call is being processed. In some implementations, the calling party may hear music while the call is being processed.

The called party receives the call and hears a prompt that states, “You are receiving a call from (Plays recorded name of the calling party). You are unable to receive collect calls to this number. In order to accept this call and be billed $x.xx for the call and have it billed directly to your handset through your mobile provider please press 1 now. To reject this call please press 2 now” as shown in block 530. If the called party denies the call, the calling party is notified that the call was rejected as shown in block 545 and the calling party may be disconnected or the calling party may be asked to enter a different number.

If the called party chooses to accept the call and depresses 1, they are played the approved the mobile campaign disclaimer and asked to accept the call again by depressing 1 as shown in block 550 of FIG. 5A. This is a double opt in process that ensures or provides a high likelihood that the called party has accepted the call and understands the terms and conditions. The called party and calling party are then connected as shown in block 555 and allowed to have a voice communication for a certain interval of time e.g. a 5 minute conversation, a 10 minute conversation, a 20 minute conversation, etc. In some implementations, the called party and the calling party may be allowed to have a voice conference that lasts an indefinite amount of time.

Once the called party accepts the collect/third party call, a text message (e.g. a premium text message) is transmitted to the called party's mobile device as shown in block 560. This message can include a receipt of service information about the service provided and details of how to contact customer service of the CTI text billing platform via 800 number or text commands. This message may also include an inspirational “Quote of the Day”. An example of a message that is transmitted can be “CTIText receipt $9.99 charged to your cell for 1 call. Msg+Data rates may apply. Reply STOP to cancel HELP for help or dial 8664482842 for more information. To have a friend, be a friend.” Other messages can be transmitted as well.

In various implementations, the message maybe sent via CTI's registered SMS short code. In various implementations, the called party's double opt in acceptance of the IVR prompts can generate the text message. The called party's mobile service provider may place the charge on the next billing cycle statement. The mobile service provider can collect the payment and then send the proceeds minus any processing charges to CTI.

In various implementations, a credit/debit card associated with the called party maybe partly charged for the collect/third party call using the ABC billing platform and the called party maybe partly charged for collect/third party call through the mobile/wireless provider by text messaging using the CTI text billing platform.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations can also be combined and implemented in a single implementation. Conversely, various features that are described in the context of a single implementation also can be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The various illustrative logical blocks, modules, circuits, and algorithm steps described in connection with the implementations disclosed herein may be implemented as electronic hardware, computer software, or combinations of both. Owing to the interchangeability of hardware and software, the various illustrative logical blocks, modules, circuits, and algorithm steps have been described generally in terms of functionality. Whether such functionality is implemented in hardware or software depends upon the particular application and design constraints imposed on the overall system.

Any hardware and data processing devices used to implement the various illustrative logical blocks, modules and circuits described herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

Implementations of the subject matter described in this specification can also be implemented as one or more computer programs, e.g., one or more modules of computer program instructions, encoded on a computer storage medium for execution by, or to control the operation of, a data processing apparatus. If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

What is claimed is:

1. A system to process and bill voice communication calls, the system comprising:
a processor configured to place calls from a calling party to a called party, the processor configured to;
receive information associated with an identity of the calling party;
receive a destination number associated with the called party;
place a call to the destination number;
prompt the called party to accept the call by paying for the call or deny the call;
process payment for the call; and
complete the call by establishing a voice connection between the called party and the calling party.

2. The system of claim 1, further including a database in electrical communication with the processor.

3. The system of claim 1, further including an interactive voice recorder in electrical communication with the processor.

4. The system of claim 1, wherein the destination number includes a mobile number or a number associated with a VoIP device.

5. A method of establishing voice communication between a calling party at a source location and a called party at a destination location, the method comprising:
receiving information associated with an identity of the calling party;
receiving a destination number associated with the called party;
placing a call to the called party at the destination number;
prompting the called party to accept the call by paying for the call or deny the call;
processing payment for the call; and
establishing a voice connection between the called party and the calling party.

6. The method of claim 5, wherein processing payment for the call comprises:
prompting the called party to enter information regarding a credit or a debit card associated with the called party;
validating the credit or debit card information; and
placing a hold on the credit card or the debit card for a certain amount of money.

7. The method of claim 5, further comprising:
generating a call detail record after the call is terminated;
processing the call detail record to obtain the amount of time for the call;
calculating an amount of money to be billed for the call based on the amount of time for the call;
billing the credit or debit card the amount of money to be billed; and
removing the hold on the credit or debit card.

8. The method of claim 5, wherein the destination number is a wireless or mobile number serviced by a wireless or mobile service provider.

9. The method of claim 8, wherein processing payment for the call comprises:
billing the called party through the wireless or mobile service provider; and
transmitting a text message including a receipt for the amount billed.

10. The method of claim 9, wherein the text message also includes an inspirational quote of the day.

11. The method of claim 8, wherein the text message is transmitted using SMS platform.
